(19) United States
(12) Patent Application Publication
(10) Pub. No.: US 2008/0069320 A1
(43) Pub. Date: Mar. 20, 2008

(54) METHOD AND SYSTEM FOR MANAGING INFORMATION COLLECTION

(75) Inventors: Lili YAO, Shenzhen (CN); Xiaojun Mo, Shenzhen (CN); Chuanbao Deng, Shenzhen (CN); Xiaojing Wu, Shenzhen (CN)

Correspondence Address: SUGHRUE MION, PLLC, 2100 PENNSYLVANIA AVENUE, N.W., SUITE 800, WASHINGTON, DC, 20037, US

(73) Assignee: HUAWEI TECHNOLOGIES CO., LTD., Shenzhen (CN)

(21) Appl. No.: 11/859,402

(22) Filed: Sep. 21, 2007

Related U.S. Application Data
(63) Continuation of application No. PCT/CN06/01766, filed on Jul. 19, 2006.

(30) Foreign Application Priority Data
Sep. 21, 2005 (CN) 200510103572.3

(51) Int. Cl. H04M 11/00

(52) U.S. Cl. 379/93.01

(57) ABSTRACT

A method for managing information collection includes: determining an information collection mode supported by a calling phone; instructing to collect information of the calling phone using the information collection mode. A method for information collection, a device for managing information collection, a device for information collection, and a system for managing information collection are disclosed as well. Using the technical solution, the information collection mode used by collecting information of a calling phone may be managed. The technical solution is applicable in a wide scope and very universal, and thus may be spread and applied widely in intelligent network services.

### FIELD OF THE TECHNOLOGY

The present invention relates to intelligent network transmission technologies, and more particularly, to methods and systems for managing information collection.

### BACKGROUND OF THE INVENTION

As prescribed in the Intelligent Network Application Protocol (INAP), after receiving an InitialDP (Initial Detection Point) operation reported by a Service Switching Point (SSP) and returning a Request Report Basic Call State Model (BCSM) Event (RRBE) message to the SSP, the Service Control Point (SCP) in an intelligent network initiatively sends a PromptAndCollectUserInformation (PC) operation to the SSP to instruct the SSP to collect the information of a calling phone. After receiving the PC operation, the SSP interacts with the calling phone to acquire a card number and a password inputted by a user with the calling phone, and reports the card number and the password acquired to the SCP for authorization.

Based on definition of the operations in the Intelligent Network Application Protocol, PC operation sent by the SCP to the SSP in the existing intelligent network services includes no information for indicating which information collection mode the SSP should use to collect information. The default information collection mode of the SSP is the Dual Tone Multi Frequency (DTMF) mode. Thus, the SSP directly uses the DTMF mode to collect information upon receiving the PC operation. However, when the DTMF mode is used to collect information, the SSP may receive and report only a user number and transfer speed of the user number is low.

With the development of intelligent network services, some new transmission modes, such as the Frequency Shift Keying (FSK) mode, have already come forth at present. In the FSK mode, information such as user number, calling user name, calling date and calling time may be received and reported. Moreover, in the FSK mode, the transfer speed of the information is much higher, which may be 30˜60 times of the transfer speed of the user number in the DTMF mode. In addition, in the FSK mode, the information being transferred may be verified.

The inventors of the present invention found that, because the PC operation sent by the SCP to an SSP includes no information for indicating which information collection mode the SSP should use to collect information; the SCP cannot manage the information collection mode used by the SSP. For a phone supporting other transmission modes, the SCP cannot manage the SSP to use the transmission mode supported by the phone to collect the information of the phone, which is very unfavorable for the spreading and application of other transmission modes in intelligent network services.

### SUMMARY OF THE INVENTION

Embodiments of the present invention provide methods and systems for managing information collection, so that the information collection mode used for collecting information of a calling phone may be managed.

An embodiment of the present invention provides a method for managing information collection, including: determining an information collection mode supported by a calling phone; instructing to collect information of the calling phone according to the information collection mode.

Optionally, the determining and the instructing are performed by a Service Control Point (SCP).

Optionally, the determining the information collection mode supported by the calling phone includes: configuring a corresponding relation of phone types and information collection modes; acquiring by an SCP a phone type of the calling phone according to an InitialDP operation reported by an SSP, determining by the SCP, an information collection mode corresponding to the phone type of the calling phone as the information collection mode supported by the calling phone according to the corresponding relation of phone types and information collection modes.

The InitialDP operation is received by the SSP from the calling phone through a calling Local Exchange, and carries the phone type of the calling phone and the SSP type of the SSP.

Optionally, the information collection mode supported by the calling phone is a Frequency Shift Keying (FSK) mode.

Optionally, the determining the information collection mode supported by the calling phone includes: configuring a corresponding relation of SSP types and information collection modes; acquiring by an SCP an SSP type of an SSP from an InitialDP operation reported by the SSP, determining by the SCP an information collection mode corresponding to the SSP type of the SSP as the information collection mode supported by the calling phone according to the corresponding relation of SSP types and information collection modes.

The InitialDP operation is received by the SSP from the calling phone through a calling Local Exchange, and carries the phone type of the calling phone and the SSP type of the SSP.

Optionally, the information collection mode supported by the calling phone is a Frequency Shift Keying (FSK) mode.

The instructing to collect information of the calling phone according to the information collection mode include: sending by an SCP a PromptAndCollectUserInformation operation carrying a parameter of the information collection mode to an SSP.

The instructing to collect information of the calling phone according to the information collection mode includes: instructing an SSP to collect information of the calling phone according to the information collection mode; and the method further includes: collecting, by the SSP, information of the calling phone according to the information collection mode.

An embodiment of the present invention provides a method for information collection, including: receiving an instruction for collecting information of a calling phone, wherein the instruction carries an information collection mode; collecting information of the calling phone according to the information collection mode.

The collecting information of the calling phone according to the information collection mode includes: interacting by an SSP with the calling phone according to the information collection mode to acquire the information of the calling phone.

The method further includes: reporting by the SSP, the information of the calling phone acquired to an SCP.

The instruction is a PromptAndCollectUserInformation operation carrying a parameter of the information collection mode; and the reporting the information of the calling phone acquired to the SCP includes: reporting a PromptAndCollectUserInformation Response including a character string response parameter indicating the information of the calling phone.

An embodiment of the present invention provides a device for managing information collection, including: a first component, configured to determine an information collection mode supported by a calling phone; and a second component, configured to instruct to collect information of the calling phone according to the information collection mode.

The first component includes: a first unit, configured to save a corresponding relation of phone types and information collection modes; a second unit configured to acquire a phone type of the calling phone according to an InitialDP operation reported by an SSP, and a third unit configured to determine an information collection mode corresponding to the phone type of the calling phone as the information collection mode supported by the calling phone according to the corresponding relation of phone types and information collection modes.

Optionally, the first component includes: a fourth unit configured to save a corresponding relation of SSP types and information collection modes; a fifth unit configured to acquire an SSP type of an SSP according to an InitialDP operation reported by the SSP, and a sixth unit configured to determine an information collection mode corresponding to the SSP type of the SSP as the information collection mode supported by the calling phone according to the corresponding relation of phone types and information collection modes.

An embodiment of the present invention provides a device for information collection, including: a unit configured to receive an instruction for colleting information of a calling phone, wherein the instruction carries an information collection mode; and a unit configured to collect information of the calling phone according to the information collection mode.

The device further includes a unit configured to report the information of the calling phone to an SCP.

An embodiment of the present invention provides a system for managing information collection, including: an SCP and an SSP; and the SCP is configured to determine an information collection mode supported by a calling phone; and instruct the SSP to collect information of the calling phone according to the information collection mode; the SSP is configured to collect information of the calling phone according to the information collection mode.

Optionally, the SCP includes: a first unit, configured to save a corresponding relation of phone types and information collection modes; a second unit, configured to acquire a phone type of the calling phone according to an InitialDP operation reported by the SSP; and a third unit, configured to determine an information collection mode corresponding to the phone type of the calling phone as the information collection mode supported by the calling phone according to the corresponding relation of phone types and information collection modes.

Optionally, the SCP includes: a fourth unit, configured to save a corresponding relation of SSP types and information collection modes; a fifth unit, configured to acquire an SSP type of the SSP according to an InitialDP operation reported by the SSP; and a sixth unit, configured to determine an information collection mode corresponding to the SSP type of the SSP as the information collection mode supported by the calling phone according to the corresponding relation of phone types and information collection modes.

In the method for managing the information collection mode of an SSP provided by an embodiment of the present invention, the corresponding relation of phone types and information collection modes, or the corresponding relation of SSP types and information collection modes is configured in the database of the SCP, and a parameter indicating an information collection mode is configured in the PC operation. Thus, when required to send the PC operation to the SSP, the SCP may determine the information collection mode supported by the calling phone based on the corresponding relation, carry the information collection mode determined in the PC operation and send the PC operation to the SSP to instruct the SSP to collect the information of the calling phone having initiated a call using the information collection mode determined.

According to an embodiment of the present invention, the SCP may manage the information collection mode used by the SSP because the SCP may send the PC operation to the SSP to instruct the SSP to collect the information of the calling phone having initiated a call using the information collection mode detected by the SCP.

For a phone supporting the FSK mode, in an embodiment of the present invention, the SSP may be managed to collect the information of the phone using the FSK mode. Thus, the characteristics of the FSK mode, rich contents of transmitted information, high transmission rate and high reliability, may be fully utilized, which enables the FSK method to be spread and applied fast.

In addition, for a phone supporting a transmission mode other than the DTMF mode and the FSK mode, the SSP may be likewise managed to collect the information of the phone using the transmission mode supported by the phone. Thus, characteristics of different transmission modes may be fully utilized, which is very favorable for the spreading and application of other transmission modes in intelligent network services.

Finally, the technical solution provided by the embodiments of the present invention is applicable in a wide scope and very universal, and thus may be spread and applied widely in intelligent network services.

### BRIEF DESCRIPTION OF THE DRAWINGS

FIG. 1 is a flow chart illustrating the process for managing the information collection mode of an SSP according to an embodiment of the present invention.

FIG. 2 is a signaling flow chart illustrating the process for managing the information collection mode of an SSP according to an embodiment of the present invention.

FIG. 3 is a signaling flow chart illustrating the process for managing the information collection mode of an SSP according to an embodiment of the present invention.

### EMBODIMENTS OF THE INVENTION

The present invention is hereinafter further described in detail with reference to the drawings as well as preferred embodiments to make the technical solution and merits thereof more apparent.

According to an embodiment of the present invention, a corresponding relation of phone types and information collection modes, or a corresponding relation of SSP types and information collection modes is configured in the database of the SCP, and a parameter indicating an information collection mode is configured in the PC operation. When the SCP needs to send PC operation to the SSP, the SCP determines the information collection mode supported by the calling phone based on the corresponding relation of phone types and information collection modes or based on the corresponding relation of SSP types and information collection modes. The SCP sends the PC operation carrying the information collection mode to the SSP to instruct the SSP to collect information of the calling phone sending call information according to the information collection mode.

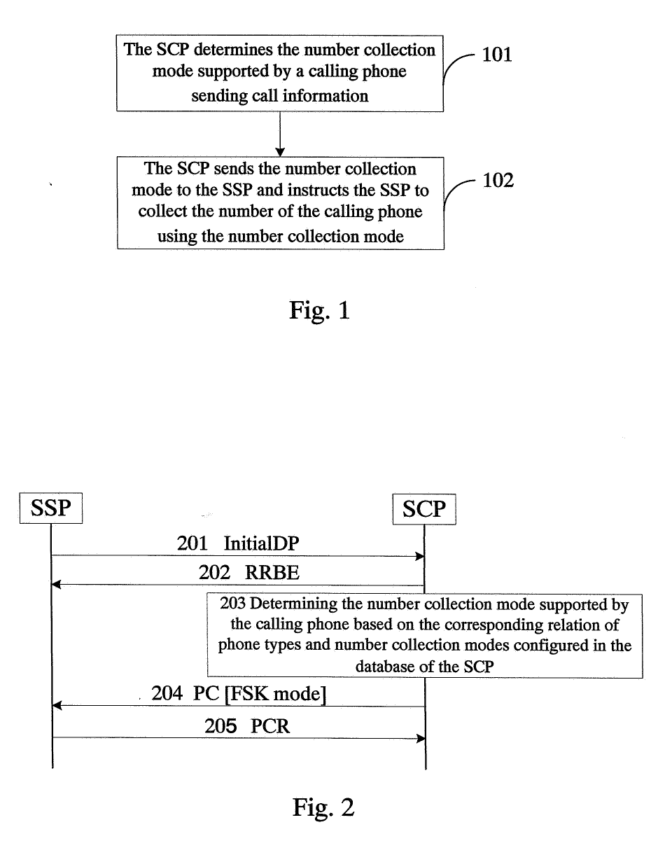

FIG. 1 is a flow chart illustrating the process for managing the information collection mode of an SSP according to an embodiment of the present invention. As shown in FIG. 1, the method includes the following.

Block 101: The SCP determines an information collection mode supported by a calling phone sending call information;

Block 102: The SCP sends the information collection mode to the SSP and instructs the SSP to collect the information of the calling phone according to the information collection mode.

In Block 101, if a corresponding relation of phone types and information collection modes is configured in the database of the SCP in advance, the SCP determines the information collection mode supported by the calling phone sending call information according to the following way, the SCP acquires the phone type of the calling phone sending call information from the call information received from the SSP, and determines whether the corresponding relation of phone types and information collection modes configured in the database of the SCP includes the phone type of the calling phone sending call information. If the corresponding relation of phone types and information collection modes includes the phone type of the calling phone sending call information, the SCP determines an information collection mode corresponding to the phone type of the calling phone sending call information as the information collection mode supported by the calling phone sending call information; otherwise, the SCP determines a default information collection mode as the information collection mode supported by the calling phone sending call information.

In Block 101, if a corresponding relation of SSP types and information collection modes is configured in the database of the SCP in advance, the SCP determines the information collection mode supported by the calling phone sending call information according to the following way, the SCP acquires the SSP type of the SSP from the call information reported by the SSP, and determines whether the corresponding relation of SSP types and information collection modes configured in the database of the SCP includes the SSP type of the SSP reporting the call information. If the corresponding relation of SSP types and information collection modes includes the SSP type of the SSP reporting call information, the SCP determines an information collection mode corresponding to the SSP type of the SSP reporting call information as the information collection mode supported by the calling phone sending call information; otherwise, the SCP determines the default information collection mode as the information collection mode supported by the calling phone sending call information.

The call information may be an InitialDP operation carrying a calling number, the phone type of the calling phone, the SSP type and an access code of the intelligent network. The corresponding relation of phone types and information collection modes, or the corresponding relation of SSP types and information collection modes is configured in the database of the SCP, and is stored in the database of the SCP generally in a form of a corresponding relation table. The corresponding relation table of phone types and information collection modes includes the phone types and the information collection modes, each of the phone types corresponds to one of the information collection modes. The corresponding relation table of SSP types and information collection modes includes the SSP types and the information collection modes, each of the SSP types corresponds to one of the information collection modes. In application, the DTMF mode is generally used as the default information collection mode.

After determining the information collection mode, in Block 102, the SCP sends PC operation carrying the information collection mode determined to the SSP and instructs the SSP to collect the information of the calling phone according to the information collection mode determined. In the existing PC operation, there is no parameter for indicating which information collection mode the SSP should use to collect the information. in one embodiment of this invention, a parameter for indicating which information collection mode the SSP should use to collect the information is added into the PC operation. The parameter is called “information collection mode”. The value of the parameter ranges 0˜127, and 0 is generally used as the default information collection mode, while 1˜127 are used as different information collection modes configured by the SCP. Because the DTMF mode is generally used as the default information collection mode, the parameter, 0, indicates that the information collection mode is the DTMF mode. The parameter, 1, may indicate that the information collection mode is the FSK mode. The parameters, 2˜127, are reserved, each of which may be used for indicating that the information collection mode is another transmission mode.

If determining that the information collection mode supported by the calling phone is the DTMF mode, the SCP configures the parameter of information collection mode in the PC operation to 0, and sends the PC operation with the parameter of information collection mode configured to 0 to the SSP to instruct the SSP to collect the information of the calling phone sending call information according to the DTMF mode. If determining that the information collection mode supported by the calling phone is the FSK mode, the SCP configures the parameter of information collection mode in the PC operation to 1, and sends the PC operation with the parameter of information collection mode configured to 1 to the SSP to instruct the SSP to collect the information of the calling phone sending call information according to the FSK mode. For the SSP, after receiving the PC operation sent by the SCP, the SSP collects the information of the calling phone sending call information according to the DTMF mode if the SSP determines that the parameter of information collection mode in the PC operation is 0; the SSP collects the information of the calling phone sending call information according to the FSK mode if the SSP determines that the parameter of information collection mode in the PC operation is 1.

After the SSP collects the information of the calling phone sending call information according to the information collection mode indicated by the SCP, in an embodiment of the present invention, in order to enable the SSP to report information acquired through interaction with the calling phone to the SCP, a character string response parameter is newly added into a PromptAndCollectUserInformation Response returned by the SSP to the SCP. The character string response parameter is used for indicating the information acquired through the interaction between the SSP and the calling phone. The character string response parameter ends with ‘\0’ and has an effective length of 126 bytes.

Detailed description is given hereinafter with reference to embodiments and the attached drawings, to make the method for managing the information collection mode of the SSP of the present invention clearer.

FIG. 2 is a signaling flow chart illustrating the process for managing the information collection mode of an SSP according to an embodiment of the present invention. In this embodiment, a corresponding relation of phone types and information collection modes is configured in the database of an SCP. As shown in FIG. 2, the method includes the following.

201: Upon receiving an InitialDP operation sent by a calling phone through a calling Local Exchange, the SSP reports the InitialDP operation to the SCP. The InitialDP operation carries such information as a calling number, a calling phone type, an SSP type and an access code of the intelligent network.

202: The SCP returns an RRBE message to the SSP upon receiving the InitialDP operation.

203: The SCP acquires the phone type of the calling phone sending call information from the InitialDP operation received from the SSP, and determines whether the corresponding relation of phones types and information collection modes configured in the database of the SCP includes the phone type of the calling phone sending call information. If the corresponding relation of phones types and information collection modes includes the phone type of the calling phone sending call information, the SCP determines an information collection mode corresponding to the phone type of the calling phone as the information collection mode supported by the calling phone sending call information; otherwise, the SCP determines a default information collection mode as the information collection mode supported by the calling phone sending call information.

In this embodiment, if the information collection mode corresponding to the phone type of the calling phone sending call information in the corresponding relation of phone types and information collection modes is the FSK mode, the SCP determines the FSK mode as the information collection mode supported by the calling phone sending call information.

204: The SCP configures the parameter of information collection mode in the PC operation to the FSK mode and sends the PC operation to the SSP to instruct the SSP to collect the information of the calling phone sending call information according to the FSK mode indicated by the parameter of information collection mode in the PC operation.

205: Upon receiving the PC operation, the SSP determines that the information collection mode indicated by the parameter of information collection mode in the PC operation is the FSK mode. The SSP interacts with the calling phone sending call information according to the FSK mode, and carries the information acquired through the interaction in the character string response parameter of a PromptAndCollectUserInformation Response (PCR) and reports the PCR to the SCP.

Therefore, the function of managing, the information collection mode of the SSP may be implemented by the SCP according to this embodiment. In order to make the method for managing the information collection mode of an SSP provided by the embodiments of the present invention clearer, a detailed description is hereinafter given with reference to one more specific embodiment and the attached drawings.

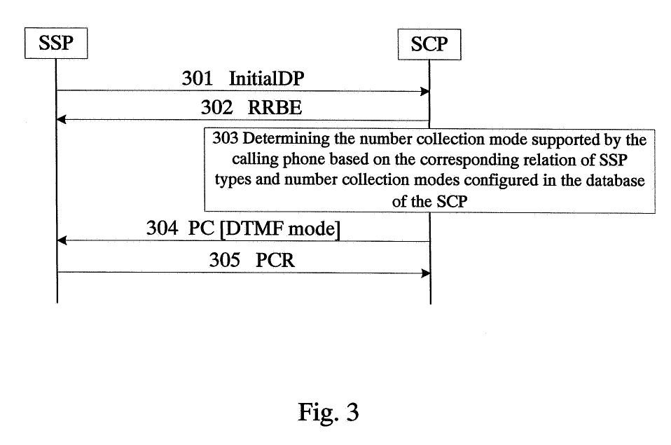

FIG. 3 is a signaling flow chart illustrating the process for managing the information collection mode of an SSP according to an embodiment of the present invention. In this embodiment, a corresponding relation of SSP types and information collection modes is configured in the database of the SCP. As shown in FIG. 3, the method includes the following.

301: Upon receiving an InitialDP operation sent by a calling phone through a calling Local Exchange, the SSP reports the InitialDP operation to the SCP. The InitialDP operation carries at least such information as a calling number, a calling phone type, an SSP type and an access code of the intelligent network.

302: The SCP returns an RRBE message to the SSP upon receiving the InitialDP operation.

303: The SCP acquires the SSP type of the SSP from the InitialDP operation reported by the SSP, determines whether the corresponding relation of SSP types and information collection modes configured in the database of the SCP includes the SSP type of the SSP having reported call information. If the corresponding relation of SSP types and information collection modes includes the SSP type of the SSP having reported call information, the SCP determines the information collection mode corresponding to the SSP type of the SSP as the information collection mode supported by the calling phone sending call information; otherwise, the SCP determines the default information collection mode as the information collection mode supported by the calling phone sending call information.

In this embodiment, if the corresponding relation of SSP types and information collection modes does not include SSP type of the SSP having reported call information, the SCP determines the DTMF mode as the information collection mode supported by the calling phone sending call information.

304: The SCP configures the parameter of information collection mode in the PC operation to the DTMF mode and sends the PC operation to the SSP to instruct the SSP to collect the information of the calling phone sending call information according to the DTMF mode indicated by the parameter of information collection mode in the PC operation.

305: Upon receiving the PC operation, the SSP determines that the information collection mode indicated by the parameter of information collection mode in the PC operation is the DTMF mode, and then interacts with the calling phone sending call information according to the DTMF mode and carries the information acquired through the interaction in a PCR and reports the PCR to the SCP.

Therefore, the function of managing, by the SCP, the information collection mode of the SSP may be likewise implemented according to this embodiment.

The purpose, technical solution and merits of the present invention have been further described in detail by the above specific embodiments. It should be appreciated that the above is only specific embodiments of the present invention and is not for use in limiting the present invention. Any modification, equivalent substitution, improvement within the spirit and principle of the present invention should be covered in the protection scope of the present invention.

What is claimed is:

1. A method for managing information collection, comprising:
determining an information collection mode supported by a calling phone;
instructing to collect information of the calling phone according to the information collection mode.

2. The method of claim 1, wherein the determining and the instructing are performed by a Service Control Point (SCP).

3. The method of claim 1, wherein the determining the information collection mode supported by the calling phone comprises:
acquiring, by an SCP, a phone type of the calling phone according to an InitialDP operation reported by a Service Switching Point (SSP); and
determining, by the SCP, an information collection mode corresponding to the phone type of the calling phone as the information collection mode supported by the calling phone according to the corresponding relation of phone types and information collection modes configured in the SCP.

4. The method of claim 3, wherein the InitialDP operation is received by the SSP from the calling phone through a calling Local Exchange, and the InitialDP operation carries the phone type of the calling phone and the SSP type of the SSP.

5. The method of claim 3, wherein the information collection mode supported by the calling phone is a Frequency Shift Keying (FSK) mode.

6. The method of claim 1, wherein the determining the information collection mode supported by the calling phone comprises:
acquiring, by an SCP, an SSP type of an SSP according to an InitialDP operation reported by the SSP; and
determining, by the SCP, an information collection mode corresponding to the SSP type of the SSP as the information collection mode supported by the calling phone according to the corresponding relation of SSP types and information collection modes configured in the SCP.

7. The method of claim 6, wherein the InitialDP operation is received by the SSP from the calling phone through a calling Local Exchange, and the InitialDP operation carries the phone type of the calling phone and the SSP type of the SSP.

8. The method of claim 6, wherein the information collection mode supported by the calling phone is a Frequency Shift Keying (FSK) mode.

9. The method of claim 1, wherein the instructing to collect information of the calling phone according to the information collection mode comprises:
sending, by an SCP, a PromptAndCollectUserInformation operation carrying a parameter of the information collection mode to an SSP.

10. The method of claim 1, wherein the instructing to collect information of the calling phone according to the information collection mode comprises:
instructing an SSP to collect information of the calling phone according to the information collection mode;
the method further comprising:
collecting, by the SSP, information of the calling phone according to the information collection mode.

11. A method for information collection, comprising:
receiving an instruction for collecting information of a calling phone, wherein the instruction carries an information collection mode; and
collecting information of the calling phone according to the information collection mode.

12. The method of claim 11, wherein the collecting information of the calling phone according to the information collection mode comprises:
interacting by an Service Switching Point (SSP) with the calling phone according to the information collection mode to acquire the information of the calling phone.

13. The method of claim 11, further comprising;
reporting, by the SSP, the information of the calling phone acquired to a Service Control Point (SCP).

14. The method of claim 13, wherein the instruction is carried by a PromptAndCollectUserInformation operation carrying a parameter of the information collection mode;
wherein the reporting the information of the calling phone acquired to the SCP comprising:
reporting a PromptAndCollectUserInformation Response carrying a character string response parameter indicating the information of the calling phone.

15. A device for managing information collection, comprising:
a first component, configured to determine an information collection mode supported by a calling phone; and
a second component, configured to instruct to collect information of the calling phone according to the information collection mode.

16. The device of claim 15, wherein the first component comprises:
a first unit, configured to save a corresponding relation of phone types and information collection modes;
a second unit, configured to acquire a phone type of the calling phone according to an InitialDP operation reported by a Service Switching Point (SSP); and
a third unit, configured to determine an information collection mode corresponding to the phone type of the calling phone as the information collection mode supported by the calling phone according to the corresponding relation of phone types and information collection modes.

17. The device of claim 15, wherein the first component comprises:
a fourth unit, configured to save a corresponding relation of SSP types and information collection modes;
a fifth unit, configured to acquire an SSP type of an SSP according to an InitialDP operation reported by the SSP; and
a sixth unit, configured to determine an information collection mode corresponding to the SSP type of the SSP as the information collection mode supported by the calling phone according to the corresponding relation of phone types and information collection modes.

18. A device for information collection, comprising:
a first unit configured to receive an instruction for colleting information of a calling phone, wherein the instruction carries an information collection mode; and
a second unit configured to collect information of the calling phone using the information collection mode.

19. The device of claim 18, further comprising:
a third unit configured to report the information of the calling phone to a Service Control Point (SCP).

20. A system for managing information collection, comprising: a Service Control Point (SCP) and a Service Switching Point (SSP); wherein
the SCP is configured to determine an information collection mode supported by a calling phone; and instruct the SSP to collect information of the calling phone using the information collection mode; and
the SSP is configured to collect information of the calling phone using the information collection mode.

21. The system of claim 20, wherein the SCP comprises:
a first unit, configured to save a corresponding relation of phone types and information collection modes;
a second unit, configured to acquire a phone type of the calling phone according to an InitialDP operation reported by the SSP; and
a third unit, configured to determine an information collection mode corresponding to the phone type of the calling phone as the information collection mode supported by the calling phone according to the corresponding relation of phone types and information collection modes.

22. The system of claim 20, wherein the SCP comprises:
a fourth database, configured to save a corresponding relation of SSP types and information collection modes;
a fifth unit, configured to acquire an SSP type of the SSP according to an InitialDP operation reported by the SSP; and
a sixth unit, configured to determine an information collection mode corresponding to the SSP type of the SSP as the information collection mode supported by the calling phone according to the corresponding relation of phone types and information collection modes.
